(19) United States
(12) Patent Application Publication
(10) Pub. No.: US 2008/0142284 A1
(43) Pub. Date: Jun. 19, 2008

(54) Double-sided dual-shaft electrical machine

(75) Inventors: Ronghai Qu, Clifton Park, NY (US); Timothy Gerard Richter, Wynantskill, NY (US); Henry Todd Young, North East, PA (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 11/639,892

(22) Filed: Dec. 15, 2006

(51) Int. Cl. B60K 1/02; H02K 16/00; H02K 7/14

(52) U.S. Cl. 180/65.6; 310/114; 310/112; 180/65.1

(57) ABSTRACT

A double-sided dual-shaft electrical machine includes a stator disposed between the inner rotor and the outer rotor. The stator includes a plurality of inner stator coils disposed adjacent to the inner rotor for driving the inner rotor. A plurality of outer stator coils disposed adjacent to the outer rotor for driving the outer rotor.

### BACKGROUND

The invention relates generally to a double-sided electrical machine for vehicles, and more particularly to a double-sided electrical machine designed to drive the vehicle wheels, and to a method for operating such machines.

Electrical machines that transform electrical energy into mechanical energy are used for various motion and drive applications. Electrical machines may include direct current (DC) motors or alternating current (AC) motors. Both DC and AC motors typically provide high performance in motion and drive applications, and both may be used in adjustable speed adjustable drive applications, although under different control regimes. For example, DC motors may be driven by variable voltage or current drives, such as by pulse-width modulation, while AC motors are typically driven by inverter drives or other variable frequency controls. AC motors may be designed for use with either polyphase or single-phase power systems. Such AC motors may include permanent magnet, switched reluctance, synchronous, and induction motors.

In certain applications such as vehicle drives, wind generators, ship propulsion system, or the like, double-sided electrical machines may be used to provide a high torque density. Such double-sided machines typically include a rotor having an inner rotor core and an outer rotor core and a double-sided stator having an inner stator side and an outer stator side. The inner rotor core and the outer rotor core are coupled to a common shaft. The double-sided stator is concentrically disposed between the inner rotor core and the outer rotor core. The double-sided stator is configured to enable at least a portion of magnetic flux to be shared between the inner stator side and the outer stator side. However, such known double-sided electrical machines are not well suited for applications such as wheel drive systems of vehicles, for example, off-highway vehicle, where wheels are required to rotate at different speeds during turning conditions of the vehicle.

In certain vehicle motion and drive applications, high-speed motors in combination with a gearbox may be used to drive the wheels of the vehicle. However, the gearbox may need maintenance and replacement at frequent intervals. Moreover, such arrangements can add significantly to the overall cost, size and weight of the motor drive system.

There is a need for improved double-sided electrical systems, and for method for driving wheels of vehicles, in which wheels coupled to opposite sides of the systems can be rotated at different speeds. Also, there is a need for a double-sided electrical system which may be used in combination with a gearbox system to drive wheels of the vehicle, or without a gearbox, as the application dictates.

### BRIEF DESCRIPTION

In accordance with one exemplary embodiment of the present invention, a double-sided electrical machine includes a stator disposed between the inner rotor and the outer rotor. The stator core includes a plurality of inner stator coils disposed adjacent to the inner rotor for driving the inner rotor. A plurality of outer stator coils disposed adjacent to the outer rotor for driving the outer rotor.

In accordance with another exemplary embodiment of the present invention, a vehicle includes a pair of wheels configured to support the chassis. A double-sided machine is coupled to the pair of wheels. The machine includes a stator disposed between the inner rotor and the outer rotor. The stator includes a plurality of inner stator coils disposed adjacent to the inner rotor for driving the inner rotor. A plurality of outer stator coils disposed adjacent to the outer rotor for driving the outer rotor.

In accordance with yet another exemplary embodiment of the present invention, a double-sided electrical machine includes an inner rotor and an outer rotor supported to the stator housing via one or more bearings. A stator is provided inside the stator housing and disposed between the inner rotor and the outer rotor. The stator includes a plurality of inner stator coils disposed adjacent to the inner rotor for driving the inner rotor. A plurality of outer stator coils disposed adjacent to the outer rotor for driving the outer rotor.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of a vehicle, for example an off-highway vehicle, incorporating a double-sided electrical machine to drive a plurality of wheels in accordance with an exemplary embodiment of the present invention;

FIG. 2 is a diagrammatical view of an exemplary double-sided electrical machine configured to drive a plurality of wheels in accordance with the exemplary embodiment of FIG. 1;

FIG. 3 is a diagrammatical view of a double-sided, dual shaft electrical machine in accordance with an exemplary embodiment of the present invention;

FIG. 4 is a diagrammatical view of another double-sided, dual shaft electrical machine in accordance with an exemplary embodiment of the present invention;

FIG. 5 is a block diagram illustrating a double-sided electrical machine provided in combination with a gearbox to drive a plurality of wheels in accordance with an exemplary embodiment of the present invention;

FIG. 6 is a block diagram illustrating another double-sided electrical machine provided in combination with a gearbox to drive a plurality of wheels in accordance with an exemplary embodiment of the present invention;

FIG. 7 is a block diagram illustrating a direct drive double-sided electrical machine configured to drive a plurality of wheels in accordance with an exemplary embodiment of the present invention; and

FIG. 8 is a block diagram illustrating a double-sided dual shaft electrical machine configured to directly drive a plurality of wheels in accordance with an exemplary embodiment of the present invention.

### DETAILED DESCRIPTION

As discussed in detail below, embodiments of the present invention provide a double-sided electrical machine with a stator disposed between an inner rotor and an outer rotor. The stator includes a plurality of inner stator coils disposed adjacent to the inner rotor for driving the inner rotor. The stator also includes a plurality of outer stator coils disposed adjacent to the outer rotor for driving the outer rotor. The inner rotor is coupled to a first rotor shaft. The outer rotor is coupled to a second rotor shaft. The stator is also enclosed within an outer stator housing. The inner rotor and the outer rotor are rotatably supported with respect to the outer stator housing via one or more bearings. The plurality of inner stator coils and outer stator coils are provided in such a way that inner stator coils and outer stator coils are separated and controllable independently. As a result, the first and second rotor shafts are rotatable at different speeds.

The double-sided machine in accordance with certain exemplary embodiments of the present invention may be desirable for certain applications such as wheel drives in off-highway vehicle in which two rotor shafts are desirable. In such applications, wheels are rotatable at different speeds, such as when the vehicle is turning. In certain applications the two rotor shafts are rotatable in different directions. The exemplary double-sided machine facilitates greater flexibility in terms of driving and turning.

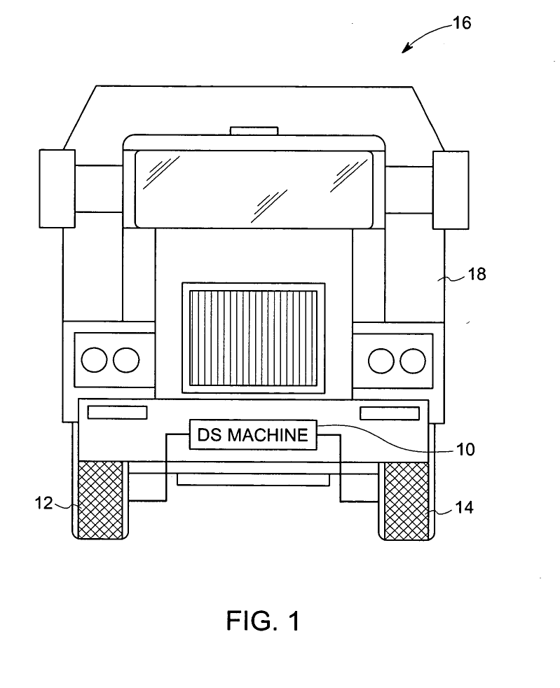

Referring to FIG. 1, an exemplary double-sided electrical machine 10 configured to drive a plurality of wheels 12, 14 of a vehicle (e.g. an off-highway vehicle) 16 in accordance with an exemplary embodiment of the present invention is illustrated. The machine 10 may include a permanent magnet machine, a switched reluctance machine, or of any other suitable electrical design. The vehicle 16 will typically include a chassis 18 supported by the plurality of wheels 12, 14. The double-sided machine 10 in accordance with certain embodiments of the present invention facilitates greater flexibility in terms of driving and turning operations. Also, because only a single exemplary double-sided machine is used for certain sets of wheels, rather than two separate motors for such wheel sets, overall cost, size, and weight are reduced. It should be noted herein that even though an off-highway vehicle is illustrated, the double-sided machine 10 may be applicable for wheel drives of other vehicles, in which greater flexibility in terms of driving and turning operations are required. Moreover, in particular applications, any number of sets of driven wheels may be provided, along with non-driven wheels, directional wheels, tracks, and so forth.

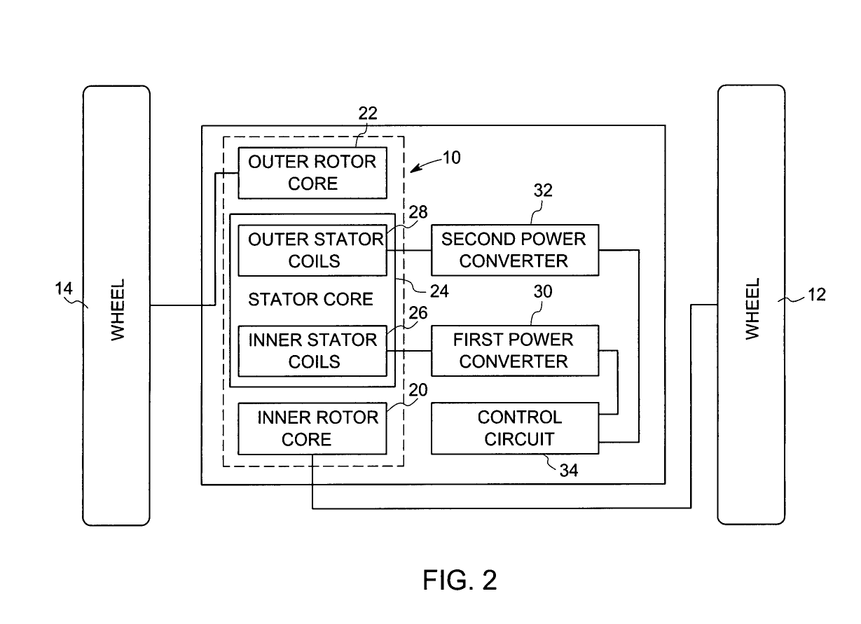

Referring to FIG. 2, the machine 10 is illustrated in accordance with a presently contemplated embodiment of the present invention. In the illustrated embodiment, the machine 10 includes an inner rotor core 20, an outer rotor core 22, and a stator core 24 disposed between the inner rotor core 20 and the outer rotor core 22. The stator core 24 includes a plurality of inner stator coils or windings 26 disposed adjacent to the inner rotor core 20 and configured to drive the inner rotor core 20. The stator core 24 also includes a plurality of outer stator coils or windings 28 disposed adjacent to the outer rotor coils 22 and configured to drive the outer rotor core 22. In the illustrated embodiment, the inner rotor core 20 is coupled to one wheel 12 and the outer rotor core 22 is coupled to the other wheel 14.

Further, the machine 10 includes a first power converter 30 coupled to the inner stator coils 26 and configured to drive the inner stator coils 26. A second power converter 32 is coupled to the outer stator coils 28 and configured to drive the outer stator coils 28. In certain embodiments, the converters 30, 32 may be coupled to a DC power source such as a battery, or to any other DC or AC power source, such as a vehicle engine generator (not shown). The converters 30, 32 are configured to convert a power signal transmitted from the DC or AC power source to a controllable AC power source to the inner and outer stator coils 26, 28. As appreciated by those skilled in the art, the converters 30, 32 may include a single-phase inverter, a multi-phase inverter, a multi-level inverter, a parallel configuration or a combination thereof. A control circuit 34 is coupled to the converters 30, 32 and is configured to control various characteristics such as frequency, and magnitude of control signals applied to the converters for producing the appropriate drive signals for the motors. The control circuit 34 facilitates to control speed and direction of rotation of the inner rotor core 20 and the outer rotor core 22 by proper application of controlled frequency signals to the stator windings. It should noted herein that the illustrated configuration of double-sided machine 10, power converters 30, 32 and the control circuit 34 is intended to be an exemplary embodiment, and not limiting in nature. The actual configuration of such drive components may vary depending on the application.

In certain other exemplary embodiments, the converters 30, 32 are coupled to an AC power source via a power source rectifier. The AC power source may comprise either a single phase AC source or a multi-phase AC source. The power source rectifier is configured to convert an AC power signal transmitted from the AC power source to a DC power signal. Similarly any number of configurations of the converters and the power sources are envisaged. In the illustrated embodiment, the inner and outer rotor cores 20, 22 are separated and controlled independently. As result, the speed and direction of rotation of the rotor cores 20, 22 are also controlled independently. Certain presently contemplated configurations of machine 10 are explained in greater detail with reference to subsequent figures.

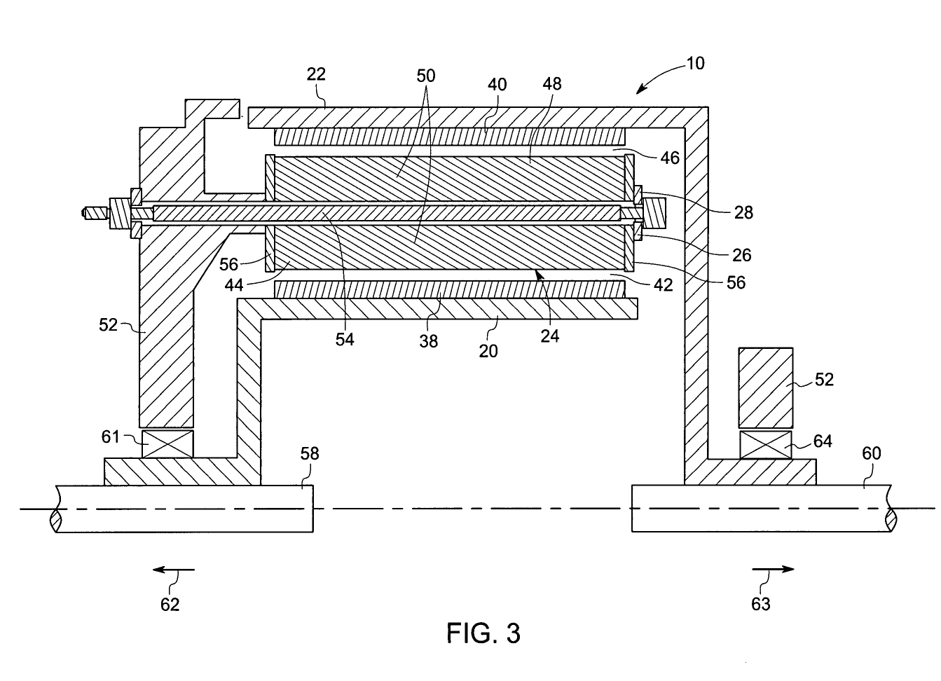

Referring to FIG. 3, a double-sided, dual shaft electrical machine 10 is illustrated in accordance with certain embodiments of the present invention. As discussed previously, the machine 10 includes the inner rotor core 20, the outer rotor core 22, and the stator core 24 disposed between the inner rotor core 20 and the outer rotor core 22. The stator core 24 further includes the plurality of inner stator coils 26 disposed adjacent to the inner rotor core 20 and the plurality of outer stator coils 28 disposed adjacent to the outer rotor core 22. It should be noted herein that the stator core 24 is disposed concentrically between the inner rotor core 20 and the outer rotor core 22. In a presently contemplated embodiment illustrated, a plurality of inner permanent magnets 38 are provided between the inner rotor core 20 and the plurality of inner stator coils 26 and coupled to the inner rotor core 20. A plurality of outer permanent magnets 40 are provided between the outer rotor core 22 and the plurality of outer stator coils 28 and coupled to the outer rotor core 22.

An air gap 42 is formed between an inner stator side portion 44 of the stator core 24 and the inner rotor core 20. Another air gap 46 is formed between an outer stator side portion 48 of the stator core 24 and the outer rotor core 22. The inner stator side portion 44 and the outer stator side portion 48 include a double-sided lamination stack 50 axially bolted to an outer stator housing 52 via axial bolts 54. The lamination stack 50 is disposed between the two core plates 56. The core plates 56 and head portions of the axial bolts 54 provide uniform compression of the stack 50. The inner stator coils 26 and the outer stator coils 28 provide magnetic flux to the inner stator side portion 44 and the outer stator side portion 48. In certain exemplary embodiments, seals, such as labyrinth or brush-type seals are provided for sealing between stator and rotor components. Other methods to hold laminations together may, of course, be used, as may other mechanisms for holding core elements together, such as welded or riveted rods, and so forth.

In the illustrated embodiment, the inner rotor core 20 is coupled to a first rotor shaft 58 and the outer rotor core 22 is coupled to a second rotor shaft 60. The first rotor shaft 58 is arranged co-axially relative to the second rotor shaft 60. As illustrated, the first rotor shaft 58 is oriented along a first direction 62 and the second rotor shaft 60 is oriented along a second direction 63 opposite to the first direction 62. The resulting structure provides high torque density (i.e., output torque per unit mass). Morever, the exemplary machine 10 in accordance with the aspects of the present invention, provides the first rotor shaft 58 rotatable independently of the second rotor shaft 60. The inner rotor core 20 is rotatably supported to the outer stator frame 52 via a first bearing 61 and the outer rotor core 22 is rotatably supported to the frame 52 via a second bearing 64. Although in the illustrated embodiment, two bearings are illustrated, alternative bearing configurations such as more than two bearings are also envisaged.

As noted above, in accordance with certain exemplary embodiments of the present invention, the inner rotor core 20 and the outer rotor core 22 are separated and are rotatable at different speeds. The inner stator coils 26 are coupled together to form one multi-phase winding and the outer stator coils 28 are coupled together to form another multi-phase winding. The two sets of multi-phase windings are driven by the power converters in such a way that each set of windings is driven independently. In one exemplary embodiment, the rotor shafts 58, 60 are rotatable along the same direction but at different speeds. In another exemplary embodiment, the shafts 58, 60 are rotatable along the same direction and at same speed. For applications such as off-highway vehicle, the first rotor shaft 58 is coupled to one wheel and the second rotor shaft is coupled to the other wheel. The exemplary machine 10 facilitates flexibility in terms of driving and turning of the wheels of the vehicle. That is, the drive signals may cause both shafts to rotate at the same speed when the vehicle is being propelled in a straight line, and at different speeds to account for different turning radii, thereby avoiding significant wear on the wheels by dragging and sliding, and improving drive traction in turns.

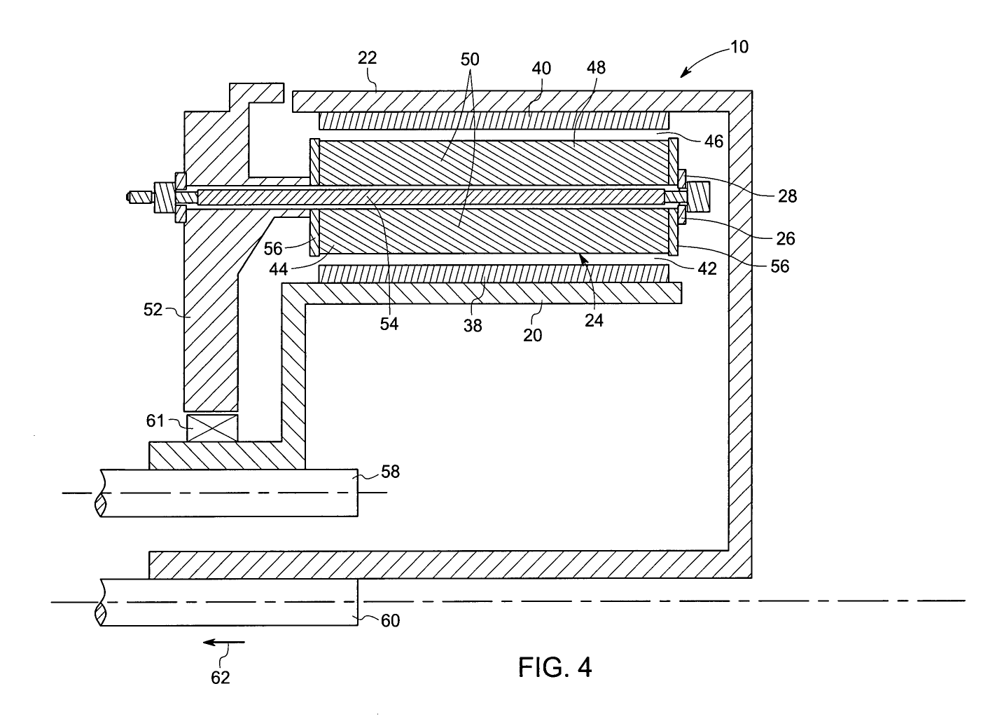

Referring to FIG. 4, another double-sided, dual shaft electrical machine in accordance with an exemplary embodiment of the present invention is illustrated as disposed concentrically between the inner rotor core 20 and the outer rotor core 22. A plurality of inner permanent magnets 38 are provided between the inner rotor core 20 and the plurality of inner stator coils 26 and coupled to the inner rotor core 20. A plurality of outer permanent magnets 40 are provided between the outer rotor core 22 and the plurality of outer stator coils 28 and coupled to the outer rotor core 28. In the illustrated embodiment, the inner rotor core 20 is coupled to the first rotor shaft 58 and the outer rotor core 22 is coupled to the second rotor shaft 60. The first rotor shaft 58 is arranged co-axially relative to the second rotor shaft 60. In the illustrated embodiment, the first rotor shaft 58 and the second rotor shaft 60 are oriented along the same direction, i.e. the first direction 62. In certain other exemplary embodiments, the first rotor shaft 58 and the second rotor shaft 60 may be oriented along the second direction 63. The exemplary machine 10 nevertheless allows for the first rotor shaft 58 to be driven and rotatable independently of the second rotor shaft 60. The inner rotor core 20 is rotatably supported to the outer stator frame 52 via the first bearing 61 and the outer rotor core 22 is rotatably supported to the frame 52 via the second bearing 64 (shown in FIG. 3). As in the previous embodiments of the present invention, the inner rotor core 20 and the outer rotor core 22 are separated and are rotatable at different speeds. Here again, the exemplary machine 10 facilitates flexibility in terms of driving and turning of the wheels of the vehicle.

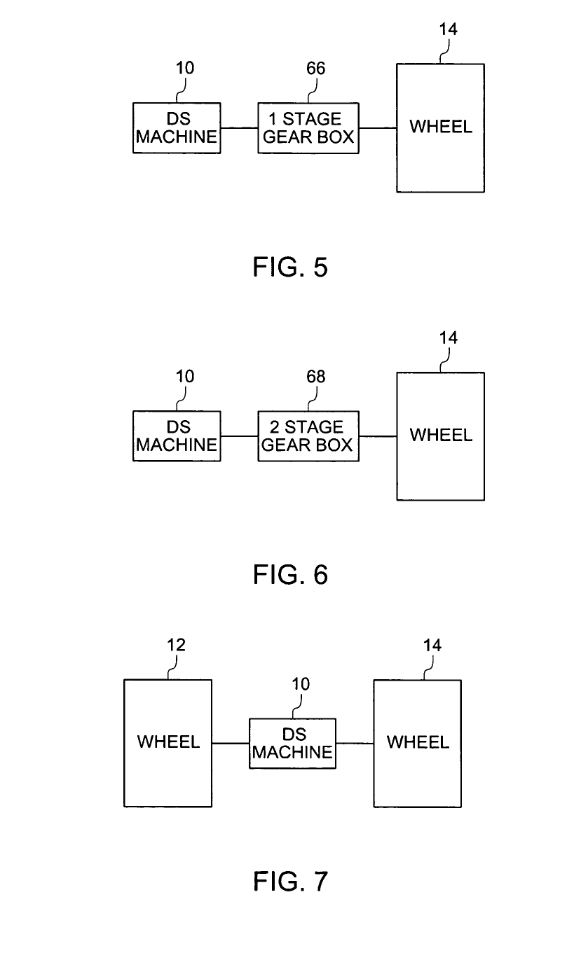

Referring to FIG. 5, a double-sided electrical machine 10 provided in combination with a single stage gearbox 66 to drive the vehicle in accordance with an exemplary embodiment of the present invention is illustrated. In the illustrated embodiment, the machine 10 (e.g., a medium speed machine) is coupled to the wheel 14 via the gearbox 66. Again referring to FIGS. 2 and 3, the second rotor shaft 60 may be coupled to the wheel 14 via the gearbox 66. In certain other exemplary embodiments, the first rotor shaft 58 may be coupled to the wheel 12 via the gearbox 66. The gearbox 66 reduces the output speed of the machine output shaft and thereby of rotation of the wheel 14. In presently contemplated embodiments, a planetary gearbox may be employed with a gear ratio of from 4 to 10. Other types and ratios of gearbox may, of course, be used. The gearbox cost may be reduced and its reliability enhanced by use of a single stage gearbox rather than a multi-stage gearbox. As a result maintenance cost may also be reduced.

Referring to FIG. 6, the double-sided machine 10 provided in combination with a two-stage gearbox 68 to drive the vehicle in accordance with an exemplary embodiment of the present invention is illustrated. In the illustrated embodiment, the machine 10 (e.g., a medium speed machine) is coupled to the wheel 14 via the 2-stage gearbox 68. The machine 10 may be a smaller size machine due to the decrease in torque consequent with the increase in speed offered by the gearbox. The machine 10 in accordance with the illustrated embodiment provides lower gear ratio and enhanced reliability. In this and the former embodiment, similar gearboxes may be provided for each output shaft of the machine.

Referring to FIG. 7, a direct drive dual-shaft double-sided electrical machine 10 configured to drive the plurality of wheels 12, 14 in accordance with an exemplary embodiment of the present invention is illustrated. In the illustrated embodiment, a lower speed machine 10 is directly coupled to the wheels 12, 14. One of the dual shafts (not illustrated) is connected to the wheel 12, and the other shaft of the dual shafts is connected to the wheel 14. The illustrated exemplary machine 10 provides higher torque, so that torque available to the wheels 12, 14 is high enough to drive the wheels 12, 14. Elimination of a gearbox may provide for reduced maintenance cost of the drive.

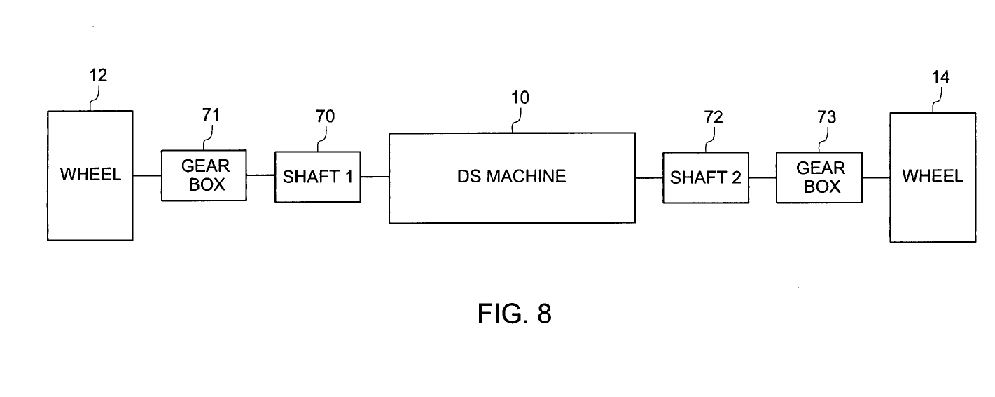

Referring to FIG. 8, a double-sided electrical machine 10 configured to directly drive a plurality of wheels 12, 14 in accordance with an exemplary embodiment of the present invention is illustrated. The machine 10 is provided with dual shafts 70, 72 coupled to the wheels 12, 14 respectively. In the illustrated embodiment, only one electrical machine 10 is required to drive the wheels 12, 14. The shaft 70 is coupled to the wheels 12, via the gear boxes 71 and the shaft 72 is coupled to the wheel 14 via the gearbox 73. The machine 10 is controllable in such a way that the shafts 70, 72 may be rotatable at the same speed or at different speeds. The cost of a dual shaft double sided machine with a greater power rating is low compared to the cost of two normal double sided machine with lower power rating since both material and labor cost are lower in a double sided dual shaft machine.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A double-sided electrical machine, comprising:
an inner rotor;
an outer rotor; and
a stator disposed between the inner rotor and the outer rotor, the stator comprising:
a plurality of inner stator coils disposed adjacent to the inner rotor for driving the inner rotor; and
a plurality of outer stator coils disposed adjacent to the outer rotor for driving the outer rotor.

2. The machine of claim 1, further comprising a plurality of inner permanent magnets disposed between the inner rotor and the plurality of inner stator coils; wherein the plurality of inner permanent magnets are coupled to the inner rotor.

3. The machine of claim 1, further comprising a plurality of outer permanent magnets disposed between the outer rotor and the plurality of outer stator coils; wherein the plurality of outer permanent magnets are coupled to the outer rotor.

4. The machine of claim 1, wherein the inner rotor is coupled to a first rotor shaft.

5. The machine of the claim 4, wherein the outer rotor is coupled to a second rotor shaft.

6. The machine of claim 5, wherein the first rotor shaft is arranged co-axially relative to the second rotor shaft.

7. The machine of claim 6, wherein the first rotor shaft is rotatable independently of the second rotor shaft.

8. The machine of claim 7, wherein the first rotor shaft is oriented in a first direction and the second rotor shaft is oriented in a second direction opposite from the first direction.

9. The machine of claim 1, further comprising a stator housing provided enclosing the stator; wherein the outer rotor is rotatably supported to the stator housing via a first bearing.

10. The machine of claim 9, wherein the inner rotor is rotatably supported to the stator housing via a second bearing.

11. A vehicle, comprising:
a chassis;
at least one pair of wheels configured to support the chassis; and
at least one double-sided machine coupled to the pair of wheels; comprising:
an inner rotor;
an outer rotor; and
a stator disposed between the inner rotor and the outer rotor; the stator comprising:
a plurality of inner stator coils disposed adjacent to the inner rotor for driving the inner rotor; and
a plurality of outer stator coils disposed adjacent to the outer rotor for driving the outer rotor.

12. The vehicle of claim 11, wherein the inner rotor is coupled to a first rotor shaft.

13. The vehicle of claim 12, wherein the first rotor shaft is coupled to one wheel of the pair of wheels.

14. The vehicle of claim 13, wherein the first rotor shaft is coupled to another wheel of the pair of wheels via a single stage gearbox.

15. The vehicle of claim 13, wherein the first rotor shaft is coupled is coupled to another wheel of the pair of wheels via a two stage gearbox.

16. The vehicle of claim 13, wherein the second rotor shaft is directly coupled to another wheel among the pair of wheels.

17. The vehicle of claim 13, wherein the outer rotor is coupled to a second rotor shaft.

18. The vehicle of claim 17, wherein the second rotor shaft is coupled to another wheel of the pair of wheels.

19. The vehicle of claim 18, wherein the second rotor shaft is coupled to another wheel of the pair of wheels via a single stage gearbox.

20. The vehicle of claim 18, wherein the second rotor shaft is coupled is coupled to another wheel of the pair of wheels via a two stage gearbox.

21. The vehicle of claim 18, wherein the second rotor shaft is directly coupled to another wheel among the pair of wheels.

22. The vehicle of claim 17, wherein the first rotor shaft is arranged co-axially relative to the second rotor shaft.

23. The vehicle of claim 17, further comprising a first power converter configured to drive the plurality of inner stator coils.

24. The vehicle of claim 23, further comprising a second power converter configured to drive the plurality of outer stator coils.

25. The vehicle of claim 24, further comprising a control circuit coupled to the first power converter and the second power converter and configured to control the speed of rotation of the first rotor shaft and the second rotor shaft.

26. The vehicle of claim 25, wherein the control circuit is configured to control the direction of rotation of the first rotor shaft and the second rotor shaft.

27. The vehicle of claim 26, wherein the first rotor shaft is oriented in a first direction and the second rotor shaft is oriented in a second direction opposite from the first direction.

28. The vehicle of claim 11, further comprising a stator housing provided enclosing the stator; wherein the outer rotor is rotatably supported to the stator housing via a first bearing.

29. The vehicle of claim 28, wherein the inner rotor is rotatably supported to the stator housing via a second bearing.

30. A double-sided electrical machine, comprising:
an inner rotor;
an outer rotor;
a stator housing; wherein the inner rotor and the outer rotor are rotatably supported to the stator housing via one or more bearings; and
a stator provided inside the stator housing and disposed between the inner rotor and the outer rotor, the stator comprising:
a plurality of inner stator coils disposed adjacent to the inner rotor for driving the inner rotor; and
a plurality of outer stator coils disposed adjacent to the outer rotor for driving the outer rotor.

31. The machine of claim 30, wherein the inner rotor is coupled to a first rotor shaft.

32. The machine of the claim 31, wherein the outer rotor is coupled to a second rotor shaft.

33. The machine of claim 32, wherein the first rotor shaft is arranged co-axially relative to the second rotor shaft.

34. The machine of claim 33, wherein the first rotor shaft is rotatable independently of the second rotor shaft.

35. The machine of claim 34, wherein the first rotor shaft is oriented in a first direction and the second rotor shaft is oriented in a second direction opposite from the first direction.

36. The machine of claim 30, wherein the outer rotor is rotatably supported to the stator housing via a first bearing.

37. The machine of claim 30, wherein the inner rotor is rotatably supported to the stator housing via a second bearing.
